(19) United States
(12) Patent Application Publication
(10) Pub. No.: US 2017/0266876 A1
(43) Pub. Date: Sep. 21, 2017

(54) NOZZLE TOOL CHANGING FOR MATERIAL EXTRUSION ADDITIVE MANUFACTURING

(71) Applicant: SABIC GLOBAL TECHNOLOGIES B.V., Bergen op Zoom (NL)

(72) Inventor: Thomas Hocker, Pittsfield, MA (US)

(21) Appl. No.: 15/531,857

(22) PCT Filed: Dec. 1, 2015
(86) PCT No.: PCT/IB2015/059263

§ 371 Date: May 31, 2017

Related U.S. Application Data
(60) Provisional application No. 62/085,843, filed on Dec. 1, 2014.

(51) Int. Cl. B29C 67/00; B33Y 30/00; B33Y 50/02; B33Y 10/00

(52) U.S. Cl. CPC B29C 67/0055; B29C 67/0088; B33Y 10/00; B33Y 30/00; B33Y 50/02; B29C 67/0092; B29K 2105/0067

(57) ABSTRACT

Systems, devices, and methods according to the present disclosure are configured for use in additive manufacturing. Systems for additive manufacturing can include stand-alone manufacturing units, a series of units on an assembly line, or a high-capacity system with workflow automation features including a conveyor for transporting parts to or from a build area, or a robotic arm for transporting parts or adjusting a system component. An additive manufacturing system can include a movable extrusion head (170) assembly and two or more extrusion nozzle cartridges (171, 172) that can be selectively coupled to the extrusion head assembly. The head assembly can include a drive assembly for use with multiple different nozzle cartridges. A portion of a nozzle cartridge can be heated when the cartridge is decoupled from the extrusion head assembly, such as to preheat a portion of the cartridge prior to a build operation using the cartridge.

### CLAIM OF PRIORITY

This application claims the benefit of priority under 35 U.S.C. §119(e) of Hocker, U.S. Provisional Patent Application Ser. No. 62/085,843, entitled “NOZZLE TOOL CHANGING FOR MATERIAL EXTRUSION ADDITIVE MANUFACTURING”, filed on Dec. 1, 2014, which is herein incorporated by reference.

### BACKGROUND

Additive manufacturing, or three-dimensional (3D) printing, is a production technology for making a solid object from a digital model. Generally, computer-aided design (CAD) modeling software is used to create the digital model of a desired solid object. Instructions for an additive manufacturing system are then created based on the digital model, for example by virtually “slicing” the digital model into cross-sections or layers. The layers can be formed or deposited in a sequential process in an additive manufacturing device to create the object.

Additive manufacturing processes offer many advantages, including potentially reducing a time period from a design phase, to a prototyping phase, to a commercialization phase. Design changes can be made throughout the development process based on a physical prototype rather than based on a digital model only or based on a prototype made from an expensive production tool. Generally, no specialized tooling is required because the same extrusion head in an additive manufacturing system can be used to create part composite shapes of many different sizes and configurations. In some examples, additive manufacturing can be used to reduce a part inventory. Using additive manufacturing, some parts can be quickly made on-demand and on-site.

Various polymers can be used in additive manufacturing, including polymers having different colors, molecular weights, flame resistance capabilities, or other characteristics. Some part composites are made using a monofilament additive manufacturing technique (for example, fused deposition modeling (FDM) or fused filament fabrication (FFF)). A monofilament can include a material strand that is about 0.1 to 3.0 mm in diameter. Some monofilament materials can bond under heat and atmospheric pressure to create a part composite that has a high degree of interaction between strand surfaces, with a small portion of voids in the bonded strands.

### Overview

The present inventor has recognized, among other things, that a problem to be solved includes increasing throughput and efficiency in an additive manufacturing system. The present subject matter can help provide a solution to this problem, such as by automating a portion of an additive manufacturing system. In an example, an additive manufacturing system according to the present disclosure can include an extrusion head assembly that is configured to receive two or more different nozzle cartridges, and each of the nozzle cartridges can be configured to dispense a different material. The extrusion head assembly can include a nozzle cartridge chassis that can be configured to receive, retain, and release a nozzle cartridge to facilitate material changes.

A nozzle cartridge tray can be provided for use with an additive manufacturing system according to the present disclosure. The nozzle cartridge tray can include at least one, but preferably two or more, nozzle cartridge receptacles that are each configured to receive respective nozzle cartridges. Each of the nozzle cartridges can include a nozzle tip for dispensing a material, and each of the cartridges can include a filament conduit for receiving a material from a material source and directing the material to the nozzle tip. The nozzle cartridge tray can include one or more temperature control devices for adjusting a temperature of at least a portion of a selected nozzle cartridge when the selected nozzle cartridge is disposed in or near the nozzle cartridge tray. In some embodiments, the nozzle cartridge tray is located outside of a build area of an additive manufacturing system, and an automated assembly, such as a robotic arm having a tool end, can be used to exchange a nozzle cartridge between the nozzle cartridge tray and the extrusion head assembly.

In an example, an additive manufacturing system according to the present disclosure can include an extrusion head assembly that is movable along vertical or horizontal axes within a build area, and is configured to detachably receive a nozzle cartridge. The system can further include at least a first nozzle cartridge, and the first nozzle cartridge can include a temperature control device that is configured to adjust a temperature of a portion of the first nozzle cartridge, such as when the first nozzle cartridge is decoupled from the head assembly, or when the first nozzle cartridge is being attached or detached from the head assembly. For example, the temperature control device can be used to preheat a portion of the first nozzle cartridge such that, when the first nozzle cartridge is secured to the extrusion head assembly using a robotic arm, the first nozzle cartridge is ready to dispense a build material without any further delay or additional temperature processing.

In an example, a method for creating a three-dimensional part, such as using an additive manufacturing system according to the present disclosure, can include preheating at least a first portion of a first nozzle cartridge outside of a build area of the system. The first nozzle cartridge can include a first nozzle tip for dispensing a first material and a first filament conduit for conveying the first material from a first material source to the first nozzle tip. The method can include coupling the first nozzle cartridge to an extrusion head assembly using a robotic arm. The method can include heating the same first portion, or a different portion, of the first nozzle cartridge, such as when the cartridge is positioned within the build area, to liquefy a portion of the first material. Once the first material is liquefied, the first material can be dispensed from the first nozzle tip to create a portion of a three-dimensional part in the build area.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of an additive manufacturing system and a control circuit.

FIG. 2A illustrates generally a perspective view of an example of a nozzle cartridge tray.

FIG. 2B illustrates generally a perspective view of an example of a nozzle cartridge for use with the nozzle cartridge tray of FIG. 2A.

FIG. 3A illustrates generally a perspective view of an example of a nozzle cartridge that is disposed in a first nozzle cartridge receptacle of a nozzle cartridge tray.

FIG. 3B illustrates generally a perspective view of an example of a nozzle cartridge perforated sheet tray.

FIG. 3C illustrates generally a perspective view of an example of a nozzle cartridge shelf tray.

FIG. 4 illustrates generally an example of a nozzle cartridge with an on-board heating system.

FIG. 5 illustrates generally an example of an extrusion head assembly with a nozzle cartridge chassis and a detachable nozzle cartridge.

FIG. 6 illustrates generally an example of a portion of an additive manufacturing system that includes an extrusion head assembly, a robotic arm, and a conveyor-based build area.

FIG. 7 illustrates generally an example of a method for creating a part composite using multiple different nozzle cartridges and respective multiple different materials.

FIG. 8 illustrates generally an example of a method for cooling a portion of a nozzle cartridge.

### DETAILED DESCRIPTION

This detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of the elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the claims, the terms “first,” “second,” and “third,” etc. are used merely as labels, and are not intended to impose numerical requirements on their objects.

Systems, devices, and methods according to the present disclosure are configured primarily for use in additive manufacturing (AM), also referred to as material extrusion additive manufacturing, deposition modeling, or three-dimensional (3D) printing. Without limiting the scope of the present disclosure, systems for additive manufacturing can include stand-alone manufacturing or printing units, a series of units on an assembly line, or a high volume system for additive manufacturing that includes one or more workflow automation features such as a conveyor for transporting parts to or from a build area, or a robot (e.g., a robotic arm) for transporting parts or adjusting a system component.

Polymeric materials can be used in the additive manufacturing systems described herein. Polymeric materials can include high-performance engineering thermoplastic polymers such as polycarbonate-based polymers (PC), polymethyl methacrylate polymers (PMMA), polyethylene terephthalate polymers (PET), polybutylene terephthalate polymers (PBT), styrene polymers, polyetherimide (PEI), acrylic-styrene-acrylonitrile polymers (ASA), and acrylonitrile-butadiene-styrene polymers (ABS), among others. The polymeric materials can include blends of these polymers together or with other polymers: for example a blend of polycarbonate and acrylonitrile-butadiene-styrene (PC/ABS), commercially available under the trade name CYCOLOY from the Innovative Plastics division of SABIC; a blend of polyphenylene ether (PPE) with other polymers, such as polystyrene, as in the blend of PPE and high-impact polystyrene (HIPS) commercially available under the trade name NORYL from the Innovative Plastics division of SABIC, or with polyamide, as in the PPE/polyamide blend available under the trade name NORYL GTX from the Innovative Plastics division of SABIC, or with polypropylene (PP), as in the PPE/PP blend commercially available under the trade name NORYL PPX from the Innovative Plastics division of SABIC. The polymeric materials can include copolymers of these polymeric base materials together or with other polymers, such as a block copolymer of PEI and siloxane, for example the amorphous block copolymer of PEI and siloxane soft-blocks commercially available under the trade name SILTEM from the Innovative Plastics division of SABIC. Polymeric and other materials, such as those suitable for use with the additive manufacturing systems and methods of the present disclosure, are discussed at length below.

Additive manufacturing systems can include, among others, systems configured to perform fused deposition modeling, or FDM. FDM is an additive process in which layers of one or more materials are successively deposited and fused together to form a part composite. Materials suitable for FDM include production-grade thermoplastics such as ABS, ASA, PC, PEI, Ultem, PET, or PBT, polyimide (e.g., EXTEM), among others. Support material used in FDM can optionally be water based.

Some examples of additive manufacturing systems include Polyjet, Selective Laser Sintering, Multijet Modeling, and Stereolithography systems. Polyjet is an additive process that uses a UV-cured photopolymer resin that can be deposited using a print head. In Selective Laser Sintering, or SLS, powdered metal or ceramic materials can be deposited and cured, such as using a laser to melt a surface of a powered material. Some materials suitable for SLS processes include nylon, titanium, and brass. In Multijet Modeling, or MJM, a microscopic layer of resin is deposited on a support made of wax, and the wax can be melted away from the part composite. In Stereolithography, a laser can be used to cure a deposited resin material. These additive manufacturing systems and others can be improved or made more efficient by employing the systems and methods described herein.

The present inventor has recognized that one way to improve throughput in an additive manufacturing system includes facilitating or expediting a tool change or material change, such as in a build process that involves multiple materials or tools to create a single part. Systems, devices, and methods described herein can help to facilitate or expedite a tool or material change by providing a nozzle cartridge tray to store one or more nozzle cartridges that are not engaged in a build process, and the stored one or more nozzle cartridges can be prepared for use in a build process when the cartridges are disposed in or near the tray. In an example, a nozzle cartridge can be preheated, such as using a heating device on-board the nozzle cartridge or using a heating device in the nozzle cartridge tray. A prepared nozzle cartridge can be coupled to an extrusion head assembly on a just-in-time or on-demand basis during a build process. In an example, multiple different additive manufacturing systems can use nozzle cartridges from a single nozzle cartridge tray.

The present inventor has recognized that another way to improve throughput in an additive manufacturing system includes decreasing a weight of an extrusion head assembly and increasing a speed at which the extrusion head assembly can move. Systems, devices, and methods described herein can help to reduce an extrusion head assembly weight by providing interchangeable nozzle cartridges, thereby reducing a number of nozzle cartridges carried by the extrusion head assembly during a build process.

Some nozzle cartridges include integrated or embedded drive systems that make such cartridges bulky or heavy. According to some embodiments of the present application, an interchangeable nozzle cartridge for use with an extrusion head assembly can include an extrusion tip and material port that can process material from a common drive system that is included in the extrusion head assembly. In some examples, the extrusion head assembly includes multiple independent drive systems that correspond to each chassis available on the extrusion head assembly for coupling with different interchangeable nozzle cartridges.

A nozzle cartridge can be configured or specialized for depositing a specified material type (e.g., a material having a specified structure, color, thickness, or other characteristic). A specialized nozzle cartridge can provide further system efficiency such as by reducing a mechanical bulkiness associated with multifunction capabilities in a general purpose nozzle cartridge. For example, in a general purpose nozzle cartridge, an adjustable nozzle tip can be provided to accommodate different material or layer deposition thicknesses, an adjustable heater can be provided to accommodate different materials having different liquefaction temperatures, or a liquefaction chamber can have a single, relatively large size, among other characteristics. In a nozzle cartridge that is specified for use with a single material or range of materials, a single nozzle tip and a single heating element can be provided, and a right-sized liquefaction chamber can be provided, such as suitable for the specified material. When a nozzle cartridge is configured for use with a specified material or range of materials, the cartridge can be more lightweight than other multifunction nozzle cartridges.

In an example, the present disclosure includes systems and devices for automatically retrieving a nozzle cartridge from a cartridge tray, securing the nozzle cartridge to an extrusion head assembly, using the secured nozzle cartridge in a build process, and replacing the nozzle cartridge in the cartridge tray. The nozzle cartridge, or an extrusion tip of the nozzle cartridge, can optionally be cleaned when the cartridge is disposed in or near the tray, or at an intermediate station between the tray and the extrusion head assembly.

The extrusion head assembly can be movable between a build area of an additive manufacturing system and the tray, and the extrusion head assembly can include coupling and releasing features for retrieving or depositing a nozzle cartridge. In some examples, one or more robotic arms or other automated devices or tools can be configured to exchange a nozzle cartridge between a nozzle cartridge tray and an extrusion head assembly. In an example, after a build process corresponding to a selected nozzle cartridge is completed, the nozzle cartridge can be optionally cleaned and replaced in the cartridge tray for storage or other processing. Using one of the movable extrusion head assembly or the robotic arm, the nozzle cartridge can be automatically cleaned, a material change-over can be automatically performed, the nozzle cartridge can be automatically calibrated, or some other function can be automatically performed on or using the nozzle cartridge.

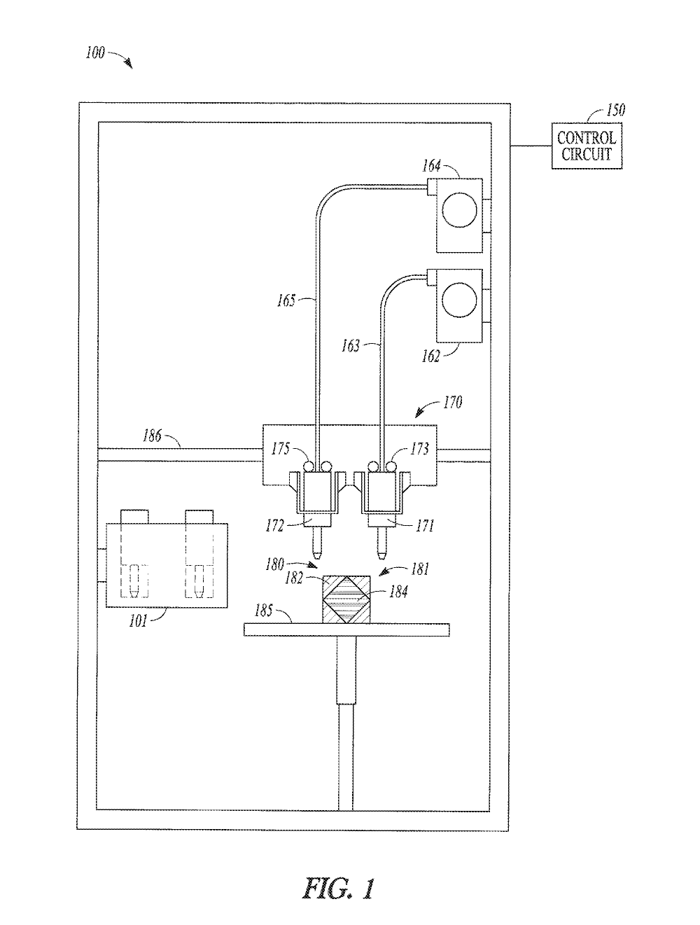

FIG. 1 illustrates generally an example of an additive manufacturing system 100. The system 100 includes a build area 180, a movable extrusion head assembly 170, and a system control circuit 150. The extrusion head assembly 170 is movable within the build area 180 under the direction of the system control circuit 150. The system control circuit 150 can include, among other things, a processor circuit or information gateway that can provide instructions to the extrusion head assembly 170, or to other portions of the system 100, and the instructions can be interpreted and used by portions of the system 100 to create a part composite 181. The part composite 181 can include one or more of a support material 182 and a model material 184.

The extrusion head assembly 170 can include, or can be configured to be coupled to, one or more nozzle cartridges. A nozzle cartridge generally includes a raw material input, a liquefier for heating successive portions of raw material, and a nozzle tip for dispensing the heated material. In some examples, the nozzle cartridge is configured to receive a polymer filament at the raw material input. A nozzle cartridge can be configured to dispense multiple different types of materials, or a nozzle cartridge can be configured to dispense a specified single material. In an example, a nozzle cartridge can include a nozzle tip that is configured for dispensing a specified material, or range of materials, at a specified material dispensing rate.

The system 100 of FIG. 1 includes a nozzle cartridge tray 101 that can be disposed in or near the build area 180. The nozzle cartridge tray 101 can include at least one nozzle cartridge receptacle that is configured to receive a nozzle cartridge such as for storage, maintenance, or other processing of the nozzle cartridge. The nozzle cartridge tray 101 can include a temperature control device for adjusting a temperature of at least a portion of a nozzle cartridge when a nozzle cartridge is disposed in or near the nozzle cartridge tray. The nozzle cartridge tray 101 can optionally include two or more nozzle cartridge receptacles, and can include global or respective temperature control devices corresponding to each of the receptacles.

The build area 180 can include, among other features, an adjustable build surface 185 and an x-y gantry 186. The adjustable build surface 185 includes a platform on which the part composite 181 can be formed. The adjustable build surface 185 is movable along a vertical z-axis, such as in response to instructions received from the system control circuit 150. The x-y gantry 186 can include a guide rail system that is configured to move the extrusion head assembly 170 in a substantially horizontal x-y plane within the build area 180. In some examples, the x-y gantry 186 or the extrusion head assembly 170 can be additionally movable in the vertical z-axis. In some examples, the adjustable build surface 185 can be movable in the horizontal x-y plane within build area 180, and the extrusion head assembly 170 can be movable along the vertical z-axis. Other arrangements can additionally or alternatively be used such that one or both of the adjustable build surface 185 and the extrusion head assembly 170 are moveable relative to each other.

The extrusion head assembly 170 is supported by the x-y gantry 186 in the example of FIG. 1, and the extrusion head assembly 170 is movable in the horizontal x-y plane to create the part composite 181 in a layer-by-layer manner using one or more of the model material 184 and the support material 182, such as in response to instructions received from the system control circuit 150. The extrusion head assembly 170 in the example of FIG. 1 includes a chassis configured to receive two nozzle cartridges, including a first nozzle cartridge 171 and a second nozzle cartridge 172. Each of the two nozzle cartridges receives a raw material, such as in filament form, from a dedicated material source. In the example of FIG. 1, the first nozzle cartridge 171 is configured to receive a filament, including a support material, from a support material source 162, by way of a first filament conduit 163. The second nozzle cartridge 172 is configured to receive a filament, including a model or part material, from a model material source 164, by way of a second filament conduit 165. The material sources can include respective spools of filament polymer that can be driven or drawn through the respective filament conduits to a specified one of the nozzle cartridges in the system 100.

The support and model materials 182 and 184 can be provided to system 100 in various media or configurations. For example, the materials can be supplied in the form of a continuous filament, such as on a spool in a filament cassette. Filaments, such as having a circular cross section, can have various diameters, such as ranging from about 1 millimeter or less to about 3 millimeters or more. In an example, at least one of the material sources can include a raw material in some form other than a filament, such as in pellet form, and a conduit suitable for transporting one or more of a solid pellet or a flowable polymer can be used to exchange raw material between a source and a nozzle cartridge.

Although the system 100 is shown with two nozzle cartridges, a system can include an extrusion head assembly 170 having a single nozzle cartridge, or a system can include an extrusion head assembly 170 having more than two nozzle cartridges, and one or more of the cartridges can optionally be removable from the extrusion head assembly 170. The extrusion head assembly 170 can include one or more nozzle cartridge drive assemblies for providing material to one or more respective nozzle cartridges. In the example of FIG. 1, the extrusion head assembly 170 includes first and second nozzle cartridge drive assemblies 173 and 174 corresponding respectively to the first and second nozzle cartridges 171 and 172. In an example, the first nozzle cartridge drive assembly 173 includes a pair of drive wheels that are spaced apart and are configured to receive a filament, such as from the support material source 162. As the drive wheels rotate, the support material can be drawn from the source and fed into the first nozzle cartridge 171. In other examples, a nozzle cartridge can include an integrated or on-board drive assembly. By providing a drive assembly on the extrusion head assembly, however, a part count, weight, and complexity associated with each nozzle cartridge can be minimized.

Support or model material 182 or 184 from respective nozzle cartridges can be deposited onto the adjustable build surface 185 to create the part composite 181. Generally, support material 182 is deposited to provide vertical support along the z-axis for overhanging portions or layers of model material 184. After a layer deposition or build operation is complete, the resulting part composite 181 can be removed from the build area 180, such as manually by an operator, or automatically using a conveyor, robotic arm, or other device to relocate the part composite 181. The support material 182 can be separated from the model material 184 before or after the part composite is removed from the build area 180. In some examples, the support material 182 can be automatically removed, dissolved, or otherwise detached from the model material 184.

In an example, one or both of the first and second nozzle cartridges 171 and 172 can be detachable from the extrusion head assembly 170, and can be replaced with other, similarly sized and shaped nozzle cartridges. One or both of the first and second nozzle cartridges 171 and 172 can be changed over the course of a build process. For example, the first nozzle cartridge 171 can be automatically decoupled from the extrusion head assembly 170 and replaced with a different nozzle cartridge, such as while the second nozzle cartridge 172 is engaged in a material deposition process. The different nozzle cartridge can optionally be preheated such that as soon as the different nozzle cartridge is coupled to the extrusion head assembly 170 and moved into position to perform a deposition process, the different nozzle cartridge can begin depositing material. In this manner, tool or material changes can be made quickly and seamlessly during a build process.

Some parts can be made from multiple different raw materials, including materials having different shapes, different chemical structures, different melting points, different extrusion or curing characteristics, different colors, or other different characteristics. In some examples, efficiencies can be gained by dedicating or configuring a specified nozzle cartridge for depositing a specified type of material, rather than to change one or more operating characteristics (e.g., a liquefier operating temperature, an extrusion tip configuration, a drive mechanism, etc.) of that nozzle cartridge at each material change. In systems where nozzle cartridges are dedicated to dispensing a particular material, material supply efficiencies can be similarly realized as raw materials need not be routinely purged from a supply conduit or liquefier assembly at a material change event. One or more nozzle cartridges having dedicated material supplies or operating characteristic set points can be stored in a holding area, such as in or near the build area 180 of the system 100, until such nozzle cartridges are needed in a build process. Once a specified nozzle cartridge (or corresponding material type) is indicated for use, the nozzle cartridge can be automatically prepared (e.g., preheated in the tray) or coupled to the extrusion head assembly 170 and then used to deposit its corresponding material. In this manner, a build process can seamlessly, and without user intervention, use multiple different material types, applied in multiple different ways, without lengthy delays during changeovers or system reconfigurations, such as due to preheating lag times.

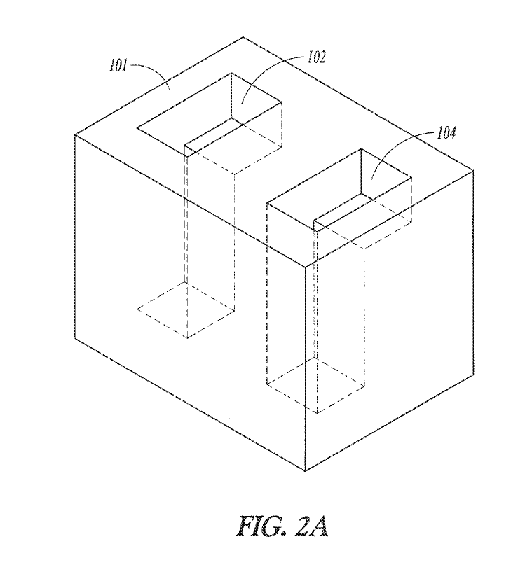

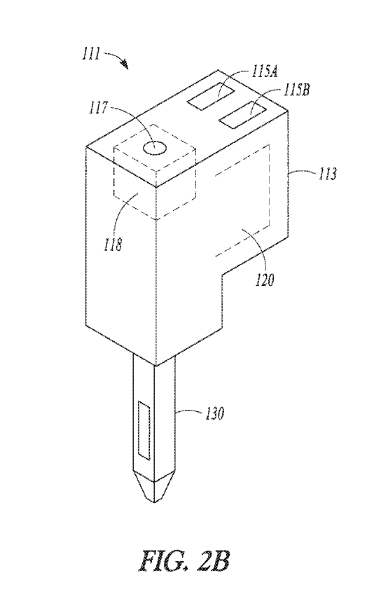

FIG. 2A illustrates generally a perspective view of an example of the nozzle cartridge tray 101. The nozzle cartridge tray 101 includes a first nozzle cartridge receptacle 102 and a second nozzle cartridge receptacle 104. FIG. 2B illustrates generally a perspective view of an example of a nozzle cartridge 111. At least one of the first and second nozzle cartridge receptacles 102 and 104 can be sized and shaped to receive or mate with at least a portion of the nozzle cartridge 111.

The nozzle cartridge 111 can include a liquefier assembly 130, such as including a nozzle extrusion tip from which liquefied or flowable model or support material can exit the nozzle cartridge 111. The nozzle cartridge 111 can include a material port 117 configured to receive a filament, pellet, or other raw material for extrusion at the liquefier assembly 130. A drive assembly 118 can optionally be provided near the material port 117 to receive or draw in raw material. In an example, the drive assembly 118 can include a pair of drive wheels that are oriented with opposing surfaces such that as the wheels rotate, a filament is drawn between the opposing wheel surfaces and fed toward the liquefier assembly 130. In some examples, the nozzle cartridge 111 does not include an on-board drive assembly, and instead receives material from a drive assembly on an extrusion head assembly.

The nozzle cartridge 111 can include one or more electrical contacts 115A and 115B, such as for exchanging an electrical communication signal with another portion of an additive manufacturing system. The electrical contacts 115A and 115B can be coupled to a nozzle control circuit 120. The nozzle control circuit 120 can be configured to provide information about a status of the nozzle cartridge 111 to the system control circuit 150. For example, the nozzle control circuit 120 can be configured to exchange information with the system control circuit 150 about one or more of a material status, a material type (e.g., sensed automatically using a sensor disposed in the nozzle cartridge 111), a liquefier assembly 130 status, a nozzle temperature, or other characteristic indicative of a nozzle cartridge status.

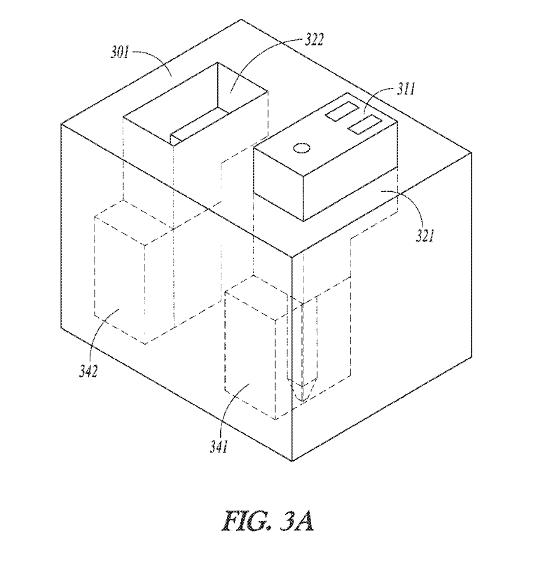

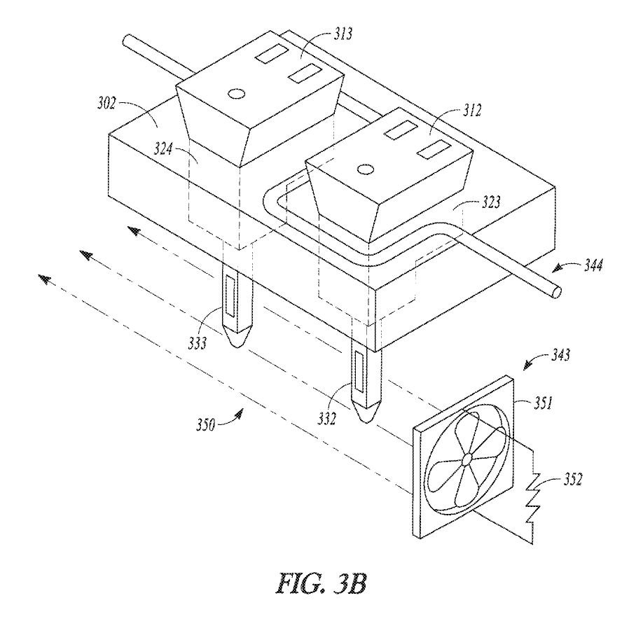

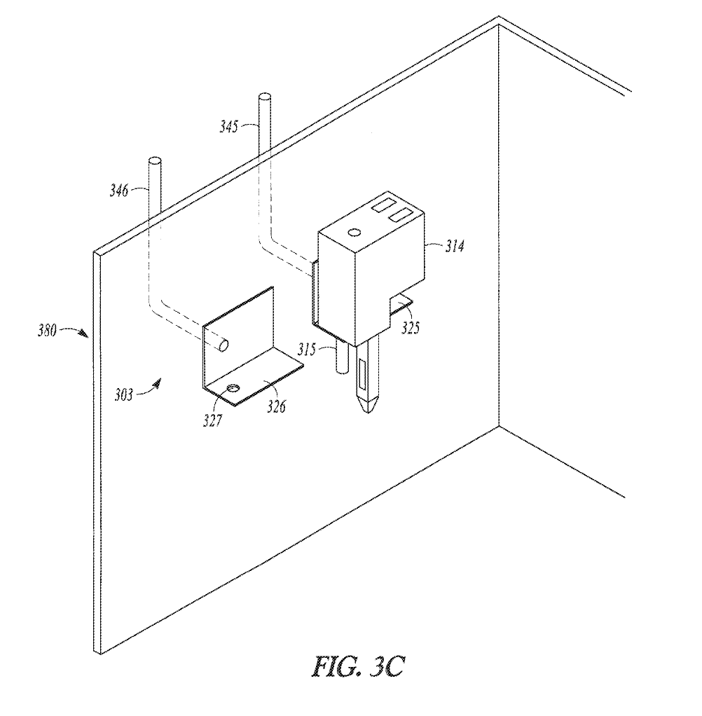

FIGS. 3A, 3B, and 3C illustrate generally perspective views of examples of nozzle cartridges disposed in different nozzle cartridge trays. In FIG. 3A, a nozzle cartridge 311 is disposed in a first nozzle cartridge receptacle 321 of a first nozzle cartridge tray 301. The first nozzle cartridge tray 301 includes a block tray with first and second nozzle cartridge receptacles 321 and 322, and can further include respective first and second temperature control devices 341 and 342.

A temperature control device in a cartridge tray can be configured to adjust a temperature of a nozzle cartridge disposed in or near a nozzle receptacle in the tray. For example, the first temperature control device 341 can include one or more of a conductive or radiant heating device, or a cooling device. The conductive or radiant heating device can be used to preheat a nozzle cartridge that is disposed in or near the first nozzle cartridge receptacle 321, for example, before the nozzle cartridge is coupled to an extrusion head for use in a build process. By preheating a nozzle cartridge, the nozzle cartridge, or a material to be dispensed by the preheated nozzle cartridge, can be ready for use in the build process when the nozzle cartridge is coupled to the extrusion head and positioned in the build area.

The cooling device can be used to cool a nozzle cartridge that is disposed in or near the first nozzle cartridge receptacle 321, for example, after the nozzle cartridge completes a build process. At least a portion of the material in the nozzle cartridge that was not dispensed during the build process can remain in a liquid, semi-liquid, or other high energy state. The material can be cooled using the cooling device, such as to help control an environment temperature of the additive manufacturing system, or to facilitate a material change, among other reasons.

The cooling device can include, among other things, a condenser coil or other conduit for providing a cooled liquid or cooled gas in a vicinity of a nozzle cartridge to absorb heat from the nozzle cartridge. In an example, the conduit can be disposed in the nozzle cartridge tray, and the conduit can wrap substantially around a portion of a nozzle cartridge, such as around an extrusion tip of the nozzle cartridge. Water or some other chemical refrigerant can be used in the conduit. In an example, the same conduit can be used for heating, such as using the same or different material inside of the conduit, or using steam.

In an example, a nozzle cartridge receptacle can include a liquid reservoir. For example, the first nozzle cartridge receptacle 321 can be partially or entirely filled with a liquid. The liquid can be heated or cooled using the first temperature control device 341 or some other heating or cooling device. For example, the liquid can be heated or cooled in a remote location and then circulated via multiple conduits into one or more reservoirs or receptacles. In an example, the liquid includes a solvent that is selected to clean or purge build or support material from a portion of a nozzle cartridge when the nozzle cartridge is disposed in the receptacle. Before or after a build event, a nozzle cartridge can be disposed (e.g., dipped, steeped, or held) in a liquid reservoir to solidify or liquefy any unused material in the cartridge.

In an example, the first nozzle cartridge receptacle 321 includes a cooled liquid (e.g., water, glycol, or some other substantially liquid solution). The cooled liquid can optionally be maintained or cooled to a temperature that is less than a flow threshold temperature of a material in a nozzle cartridge, such as the nozzle cartridge 311. For example, the cooled liquid can be maintained or cooled to a temperature that is about 20 degrees Celsius less than the flow threshold temperature of the material in the nozzle cartridge 311. When the nozzle cartridge 311 is seated into the first nozzle cartridge receptacle 321, the cooled liquid contacts any unused material in the tip of the nozzle cartridge 311 and the unused material is solidified to prevent release of the unused material from the nozzle cartridge 311.

In an example, the first nozzle cartridge receptacle 321 includes a heated liquid (e.g., water, glycol, or some other substantially liquid solution). The heated liquid can optionally be maintained or heated to a temperature that is greater than a flow threshold temperature of a material in a nozzle cartridge, such as the nozzle cartridge 311. For example, the heated liquid can be maintained or heated to a temperature that is about 20 degrees Celsius greater than the flow threshold temperature of the material in the nozzle cartridge 311. When the nozzle cartridge 311 is seated into the first nozzle cartridge receptacle 321, the heated liquid contacts any unused material in the tip of the nozzle cartridge 311 and the unused material is liquefied to drain or purge the unused material from the nozzle cartridge 311. Material separated from the nozzle cartridge 311 by the heated liquid can be drained away from the nozzle cartridge 311 to avoid contaminating other portions of the nozzle cartridge 311 with the unused material.

A material change or other process can follow cartridge processing at the first nozzle cartridge tray 301. For example, the first nozzle cartridge receptacle 321 can include a cooled liquid. After a first build event, the nozzle cartridge 311 can be deposited in the first nozzle cartridge receptacle 321 to arrest material flow from the nozzle cartridge 311, such as by solidifying the material in the nozzle cartridge 311. Once the material flow is stopped, the source material can optionally be changed. When the same nozzle cartridge 311 is required for a subsequent build event, the nozzle cartridge 311 can be removed from the first nozzle cartridge receptacle 321, optionally pre-heated, and returned to the build area to complete the subsequent build event. In an example, the second nozzle cartridge receptacle 322 includes a heated liquid, and the pre-heating includes moving the nozzle cartridge 311 to the second nozzle cartridge receptacle 322 to be pre-heated before the nozzle cartridge 311 is returned to the build area.

The first and second temperature control devices 341 and 342 can be of a similar or dissimilar type. For example, the first and second temperature control devices 341 and 342 can be resistive heating devices, or one of the first and second temperature control devices 341 and 342 can be a resistive heating device and the other of the first and second temperature control devices 341 and 342 can be a liquid cooling device. One or more types of temperature control devices can be used to accommodate different nozzle cartridges or different materials.

A temperature control device can include a system for providing heated or cooled air or liquid to a nozzle cartridge. For example, the first temperature control device 341 in the first nozzle cartridge tray 301 can include a port for dispensing or receiving heated or cooled air or liquid (see, e.g., FIG. 3C). A nozzle cartridge can optionally include a mating port for receiving the dispensed heated or cooled air or liquid. For example, a nozzle cartridge can include a conduit or path through a portion of the nozzle cartridge, such as near a liquefier assembly or nozzle tip, and the conduit or path can pass a heated or cooled air or liquid to change a temperature of a material in a corresponding portion of the nozzle cartridge.

In an example, the port in the first nozzle cartridge tray 301 can dispense a liquid over a portion of a nozzle cartridge when the nozzle cartridge is disposed in or near the nozzle cartridge tray. The dispensed liquid can be collected below the nozzle cartridge and optionally recycled (e.g., with or without heating or cooling) to provide further heating or cooling over the same or different nozzle cartridge. In an example, the dispensed liquid or gas can include a solvent that is configured to clean the nozzle cartridge or to remove an excess material at the nozzle tip.

In an example, at least one of the first and second temperature control devices 341 and 342 includes a resistive heater (sometimes referred to as a Joule heater or ohmic heater). The resistive heater includes an electric conductor that can receive or pass an electric current and, in response, release heat. Generally, the amount of heat released is proportional to the square of the current in the conductor. The resistive heater can be included in the first nozzle cartridge tray 301, or a portion of the resistive heater can be included in a nozzle cartridge. That is, the electric conductor configured to release heat can be included in the nozzle cartridge tray (e.g., in the first temperature control device 341), in the nozzle cartridge 311, or in both. In an example, the second temperature control device 342 in the first nozzle cartridge tray 301 includes electrical contacts configured to supply an electric current to a conductor included in the nozzle cartridge 311, and the conductor in the nozzle cartridge 311 is configured to release heat in response to an electric current received from the electrical contacts.

In an example, at least one of the first and second temperature control devices 341 and 342 includes a portion of an induction or inductive heater. A portion of the inductive heater can be included in a nozzle cartridge and a portion of the inductive heater can be included in the first nozzle cartridge tray 301. The temperature control device in the first nozzle cartridge tray 301 can include an electrical conductor, configured as an electromagnet, through which an alternating electrical current (AC current) can be provided. A conductive material in a nozzle cartridge can be positioned such that, when the nozzle cartridge is disposed in or near a receptacle in the first nozzle cartridge tray 301, heat is generated in the conductive material as a result of eddy currents induced in the conductive material in response to the AC current. The temperature can be thereby increase at the portion of the nozzle cartridge corresponding to the conductive material.

The examples of FIGS. 2A, 2B, and 3A illustrate generally examples of nozzle cartridge trays that can receive and substantially encapsulate a portion of a nozzle cartridge. Alternative configurations can be similarly used. FIG. 3B illustrates generally a perspective view of an example of a perforated sheet tray 302. FIG. 3C illustrates generally a perspective view of an example of a shelf tray 303. A temperature control device can be included in the sheet tray 302 or the shelf tray 303, or a temperature control device can be included in a nozzle cartridge that is configured to be stored in or at the sheet tray 302 or the shelf tray 303. The sheet tray 302 or the shelf tray 303 can optionally include one or more electrical or mechanical contacts that can exchange information with a nozzle cartridge. In an example, a mechanical switch on one or more of the sheet tray 302 or the shelf tray 303 is actuated when a nozzle cartridge is disposed in the tray.

The example of the sheet tray 302 in FIG. 3B includes first and second nozzle cartridge receptacles 323 and 324. The nozzle cartridge receptacles can include respective through-holes in the sheet tray 302 that are configured to receive respective nozzle cartridges. In an example, first and second tapered nozzle cartridges 312 and 313 can be used. A tapered nozzle cartridge can have a body portion with at least one tapered side such that a bottom portion of the nozzle cartridge is narrower than an upper portion of the nozzle cartridge. When the tapered nozzle cartridge is disposed in one of the first and second nozzle cartridge receptacles 323 and 324, a portion of the nozzle cartridge can extend below a bottom surface of the sheet tray 302 and a portion of the nozzle cartridge can be disposed above a top surface of the sheet tray 302, as shown in FIG. 3B.

A third temperature control device 343 can be provided to adjust a temperature of a nozzle cartridge disposed in the sheet tray 302. In the example of FIG. 3B, the third temperature control device 343 includes an airflow assembly, including a blower fan 351 and a resistive heater 352. The blower fan 351 can be positioned to direct an airflow 350 over a surface of the resistive heater 352 and in the direction of the first and second tapered nozzle cartridges 312 and 313. In an example, the first and second tapered nozzle cartridges 312 and 313 include respective first and second nozzle tip assemblies 332 and 333. The airflow 350 can be configured to flow around the first and second nozzle tip assemblies 332 and 333 to heat the tips. In an example, a dedicated temperature control device (e.g., a blower fan and heater system) can be provided for each of the nozzle cartridge receptacles in the sheet tray 302 such that a temperature characteristic of each nozzle cartridge in the sheet tray 302 can be individually controlled.

One or more other temperature control devices can additionally or alternatively be used with the third temperature control device 343 and the sheet tray 302. For example, a fourth temperature control device 344 can include a conduit configured to pass a heated or cooled substance in a region near the first and second nozzle cartridge receptacles 323 and 324. In an example, the conduit can be disposed near a liquefier chamber in a nozzle cartridge when the nozzle cartridge is disposed in the sheet tray 302, and the conduit can be configured to provide heating or cooling to the liquefier chamber in the nozzle cartridge.

Referring now to FIG. 3C, the example of the shelf tray 303 includes first and second nozzle cartridge shelves 325 and 326. The first and second nozzle cartridge shelves 325 and 326 can optionally be disposed in or near a build area 380 of an additive manufacturing system (e.g., corresponding to the build area 180 of the system 100 in FIG. 1). A nozzle cartridge shelf can be configured to receive and store one or more nozzle cartridges for preheating, cooling, or other maintenance.

A nozzle cartridge shelf can include one or more through-holes or other mechanical features that are configured to receive a nozzle cartridge, or to receive one or more corresponding features of a nozzle cartridge. In an example, a shelf-mountable nozzle cartridge 314 can include a peg 315 that is configured to be received in a mating through-hole 327 of the first nozzle cartridge shelf 325, such as to retain or secure the shelf-mountable nozzle cartridge 314 at the first nozzle cartridge shelf 325 when the cartridge is not coupled to the extrusion head assembly. An additional through-hole can optionally be provided for a nozzle tip of the shelf-mountable nozzle cartridge 314.

Fifth and sixth temperature control devices 345 and 346 can be provided to adjust respective temperatures of nozzle cartridges disposed at each of the first and second nozzle cartridge shelves 325 and 326. In an example, the fifth temperature control device 345 includes a conduit for providing an air or liquid flow to the first shelf-mountable nozzle cartridge 314 for heating or cooling a portion of the first shelf-mountable nozzle cartridge 314. The air or liquid flow can be configured to flow around or through a portion of the first shelf-mountable nozzle cartridge 314, such as near a liquefier assembly or nozzle tip of the cartridge, to heat or cool a material therein. In an example, the conduit can additionally or alternatively supply a solvent for dispensing around the nozzle tip of the cartridge for cleaning the tip, such as by dissolving any residual material after the nozzle cartridge is used in a build process.

In other examples, a nozzle cartridge tray can include a substantially open configuration, such as a planar mesh configured to receive a portion of a nozzle cartridge. In an example, a nozzle cartridge tray can include a hook or series of hooks, and a nozzle cartridge can include a loop or other feature configured to mate with the tray hook. In an example, a sidewall portion of a nozzle cartridge can be metallized or magnetized and the tray can include a mating metallized or magnetic surface (e.g., a substantially vertical surface) for receiving or holding the cartridge.

The examples of FIGS. 3A, 3B, and 3C show cartridge trays having two nozzle cartridge receptacles each, however, embodiments with additional nozzle cartridge receptacles are contemplated, as are embodiments that use multiple different types of cartridge trays in a single system.

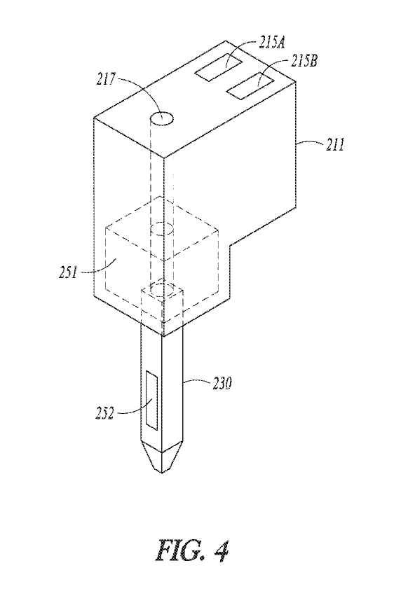

FIG. 4 illustrates generally an example of a nozzle cartridge 211 that includes an on-board heating system. The example of the nozzle cartridge 211 further includes first and second electrical contacts 215A and 215B, such as for exchanging data or receiving power from a control circuit, and the nozzle cartridge 211 includes a filament conduit 217 that is configured to receive a polymer in filament form, such as for liquefaction in the nozzle cartridge 211 and dispensing at the nozzle cartridge tip 230.

The on-board heating system can optionally be used when the nozzle cartridge 211 is disposed in or near a cartridge tray, or the on-board heating system can be used when the nozzle cartridge 211 is coupled to an extrusion head assembly, or both. In the example of FIG. 4, the on-board heating system includes a first heating element 251 and a second heating element 252. The first heating element 251 corresponds to a liquefier chamber inside of the nozzle cartridge 211, and the second heating element 252 corresponds to the nozzle cartridge tip 230. In an example, the first heating element 251 can begin heating the liquefier chamber inside of the nozzle cartridge 211 when the nozzle cartridge 211 is disposed in a cartridge tray. When the nozzle cartridge 211 is coupled to an extrusion head assembly and positioned in a build area, the second heating element can be activated to heat material at or near the nozzle cartridge tip 230 to release the material into the build area. One or more other heating or cooling elements can additionally or alternatively be used, such as elements disposed in a cartridge tray, to influence a temperature of the nozzle cartridge 211.

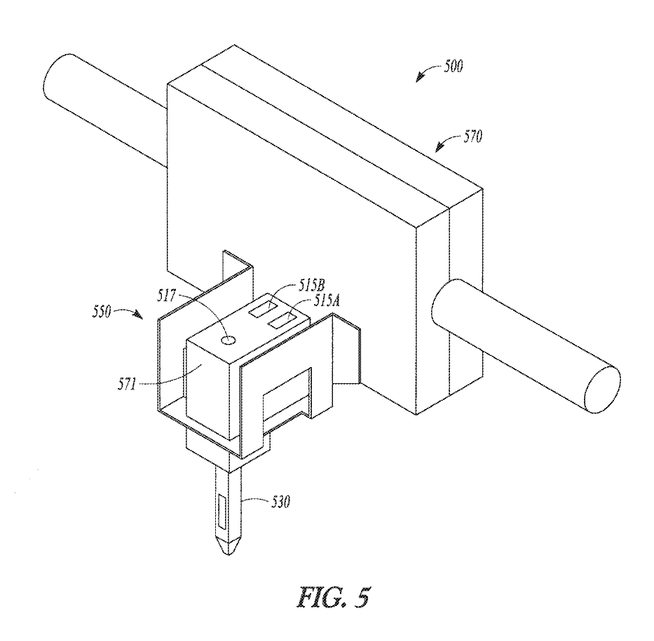

FIG. 5 illustrates generally an example 500 of an extrusion head assembly 570 and a nozzle cartridge 571 that is detachable from the extrusion head assembly 570. The nozzle cartridge 571 can include any one or more of the nozzle cartridges discussed herein, and can optionally include one or more on-board heating or cooling devices. The nozzle cartridge 571 includes a material port 517, such as for receiving a material filament, and electrical contacts 515A and 515B. The extrusion head assembly 570 includes a nozzle cartridge chassis 550 that is configured to receive and secure the nozzle cartridge 571 for use in a build process.

In an example, the nozzle cartridge chassis 550 includes one or more through-holes to accommodate features of the nozzle cartridge 571, such as a nozzle cartridge tip 530 of the nozzle cartridge 571. One or more additional through-holes can be provided in the nozzle cartridge chassis 550 for mating with corresponding features in the nozzle cartridge to facilitate aligning the nozzle cartridge 571 in the nozzle cartridge chassis 550.

The nozzle cartridge chassis 550 can optionally open or unfold away from the nozzle cartridge 571 to release the nozzle cartridge 571. In an example, a pick-and-place robot can retrieve the nozzle cartridge 571 from the nozzle cartridge chassis 550 and move the nozzle cartridge 571 to a tray for storage, cleaning, or other processing. In an example, the pick-and-place robot can move the nozzle cartridge 571 to a different additive manufacturing system for use in a different build process.

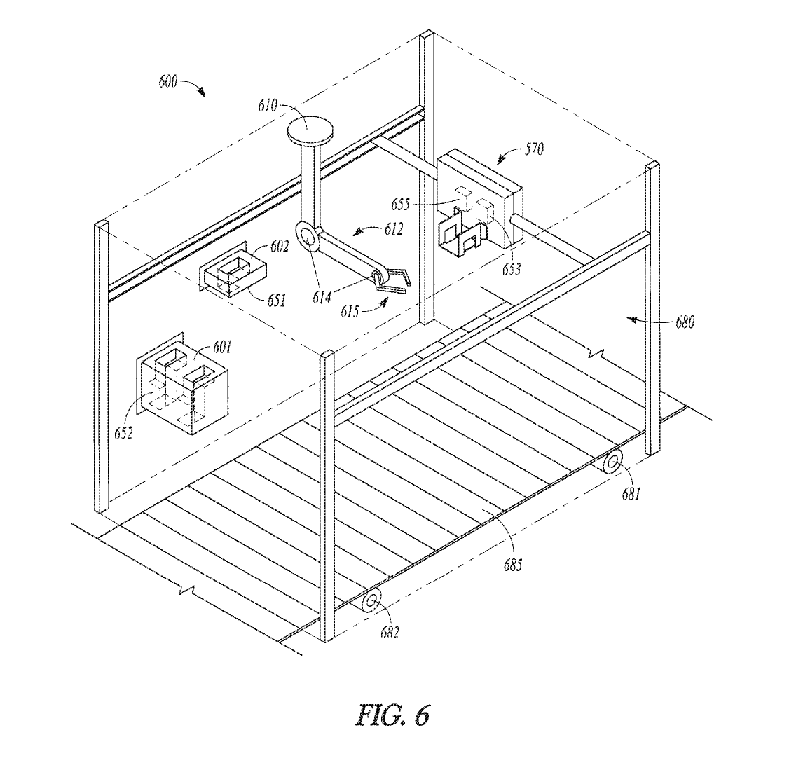

FIG. 6 illustrates generally an example of a portion of an additive manufacturing system 600 that includes the extrusion head assembly 570 mounted on a robot gantry 686. In the example of FIG. 6, the extrusion head assembly 570 is shown without the nozzle cartridge 571. The extrusion head assembly 570 can optionally include a liquefier assembly 655, a temperature control device 653, or a drive assembly. The liquefier assembly 655 can be used to liquefy a material supplied (e.g., in filament form) directly to the extrusion head assembly 570 from a material source. The temperature control device 653 can optionally be used to heat the liquefier assembly 655, or to heat a portion of a nozzle cartridge that is installed in the chassis of the extrusion head assembly 570.

The robot gantry 686 can include a Cartesian robot, x-y gantry system, or x-y-z gantry system for movement in horizontal and/or vertical planes within a build area 680 of the system. The build area 680 can include an adjustable build surface 685. In the example 600, the build surface 685 is shown as a portion of a conveyor belt. The top surface of the conveyor belt can optionally be raised or lowered, such as using one or more adjustable rollers 681 and 682, throughout a build process.

The example system 600 includes first and second nozzle cartridge trays 601 and 602. The first nozzle cartridge tray 601 includes multiple nozzle cartridge receptacles, and each of the nozzle cartridge receptacles is configured to heat or cool a portion of a nozzle cartridge. The second nozzle cartridge tray 602 includes a single nozzle cartridge receptacle. In an example, the second nozzle cartridge tray 602 is configured for specialized heating or cooling of a nozzle cartridge, or is configured to receive a specified nozzle cartridge type (e.g., a nozzle cartridge configured only to deposit a support material, or a nozzle cartridge configured only to deposit a model material, such as using an elevated liquefaction temperature).

The example 600 includes a robot assembly 610. The robot assembly 610 includes multiple robotic arm linkages 612, multiple robotic arm joints 614, and a robot tool 615. In an example, one or more of the multiple robotic arm joints 614 includes AC or DC motors configured to bend or rotate the various robotic arm linkages 612, to position the robot tool 615 at one or more of the first and second nozzle cartridge trays 601 and 602, or at the extrusion head assembly 570, or at one or more other locations. In an example, the robot tool 615 includes a robot hand, vacuum, or other device configured to pick up and release a nozzle cartridge.

In an example, the robot tool 615 can be configured to perform a material change at a nozzle cartridge when the nozzle cartridge is disposed in a cartridge tray, at an extrusion head assembly, or at some other location. For example, the robot tool 615 can be configured to remove a first filament, purge a liquefaction chamber (e.g., by moving the nozzle cartridge to a purging device in the system), and inserting a second filament into the nozzle cartridge.

The robot assembly 610 and the robot tool 615 can be controlled, for example, using the control circuit 150, or using another processor circuit in communication with the control circuit 150. Although not shown in the figures, the robot assembly 610 can optionally be translated in substantially horizontal and/or vertical planes using a robotic arm gantry. In an example, the robot assembly 610 can be mounted to the extrusion head assembly 570, or the robot assembly 610 can be configured to use a portion of the robot gantry 686.

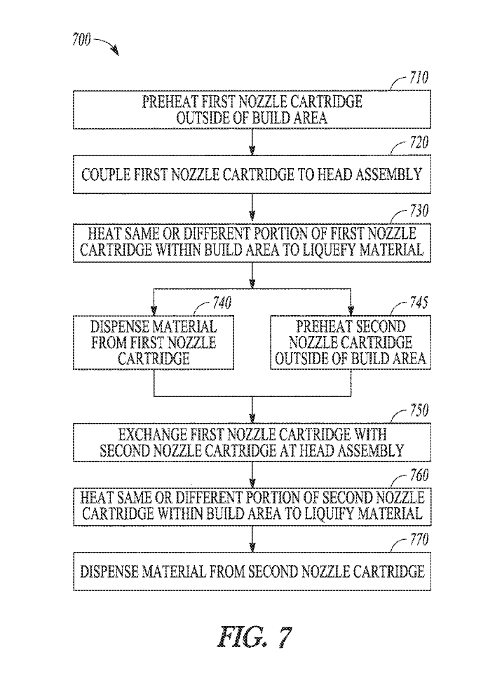

The systems and devices discussed herein can be applied using various methods to create a part composite using model or support materials. FIG. 7, for example, can include a method 700 for creating a part composite using multiple different nozzle cartridges and respective multiple different materials. At 710, the method 700 includes preheating a first nozzle cartridge outside of a build area of an additive manufacturing system.

In an example, the preheating at 710 can include using a heating device in a nozzle cartridge tray to adjust a temperature of a first nozzle cartridge that is disposed in or near the nozzle cartridge tray. Examples of nozzle cartridge trays are shown in FIGS. 1, 2A, 3A, 3B, 3C, and 6, although other nozzle cartridge trays can be used. In an example, the preheating at 710 can include using a heating device that is on-board or integrated with a nozzle cartridge. The heating device can adjust a temperature of the nozzle cartridge, or of a material inside of the nozzle cartridge, such as when the nozzle cartridge is disposed in or near the nozzle cartridge tray. In some examples, the nozzle cartridge tray is a passive tray that provides a holding area. In other examples, the nozzle cartridge tray includes one or more temperature control devices that selectively provide heating or cooling at one or more nozzle cartridge receptacles to change a temperature of one or more nozzle cartridges when the cartridges are disposed in or near the tray.

At 720, the nozzle cartridge, such as the first nozzle cartridge that was preheated at 710, can be coupled to an extrusion head assembly for use in a build process. A robotic arm can optionally be used to relocate the nozzle cartridge from the preheating location (e.g., in or near a nozzle cartridge tray) to the extrusion head assembly. In an example, the extrusion head assembly is movable between a build area and a nozzle cartridge tray, and the extrusion head assembly includes one or more automated features that can facilitate coupling or decoupling a nozzle cartridge with the extrusion head assembly.

At 730, the method 700 includes heating a portion of the first nozzle cartridge to liquefy a build material (e.g., a model or support material) for use in a build process. The same portion or a different portion of the nozzle cartridge that was preheated at 710 can be heated at 730. In an example, the preheating at 710 can include heating a liquefier or nozzle tip portion of the nozzle cartridge to a temperature below a liquefaction temperature of the build material. The heating at 730 can include heating the liquefier or nozzle tip portion of the nozzle cartridge to the liquefaction temperature such that the build material can flow from the nozzle tip. At 740, the method 700 can include dispensing the build material from the first nozzle cartridge.

At 745, such as while the build material is dispensing from the first nozzle cartridge at 740 in a build process to create a part composite, a second nozzle cartridge can be preheated. The second nozzle cartridge can be preheated outside of the build area of the additive manufacturing system. In an example, the preheating at 745 includes using a heating device in a nozzle cartridge tray, such as the same nozzle cartridge tray that was used at 710 for preheating the first nozzle cartridge. In an example, the preheating at 745 includes using a heating device that is on-board or integrated with the second nozzle cartridge.

At 750, the first nozzle cartridge can be exchanged with the preheated second nozzle cartridge. The first nozzle cartridge can be removed from the extrusion head assembly, such as using a robotic arm or other automated device, when the portion of the build process corresponding to the first nozzle cartridge is completed. The first nozzle cartridge can then be placed in the nozzle cartridge tray, such as in the same location that the first nozzle cartridge was in before the material deposition process (e.g., during the preheating at 710), or the first nozzle cartridge can be placed in a different location in the same tray. In an example, the first nozzle cartridge can be placed in a different nozzle cartridge tray, or the first nozzle cartridge can be placed in an intermediate tray, such as for cooling, before being deposited in the tray.

In an example that includes an extrusion head assembly having multiple nozzle cartridge chassis, the first nozzle cartridge can remain coupled to a first chassis on the extrusion head assembly, and the second nozzle cartridge can be coupled to a second chassis on the extrusion head assembly. In this example, the first nozzle cartridge can be held dormant or inactive while the second nozzle cartridge is used in a deposition process. In the inactive condition, a temperature of a portion of the first nozzle cartridge can be reduced, such as to prevent material from being released from the first nozzle cartridge while the second nozzle cartridge is used in the build process. In an example, the first and second nozzle cartridges can be used simultaneously to build different portions of the same part composite. In such examples, the respective chassis on the extrusion head assembly can optionally be independently movable, such as relative to a body of the extrusion head assembly, in the build area of the system.

At 760, such as after the second nozzle cartridge is coupled to the extrusion head assembly, and optionally occurring while the first nozzle cartridge travels to the nozzle cartridge tray, the method 700 can include heating a portion of the second nozzle cartridge to liquefy a build material for use in the build process. In an example, the same portion of the second nozzle cartridge that was preheated at 745 can be heated at 760, or a different portion of the second nozzle cartridge can be heated at 760. In an example, the preheating at 745 can include heating a liquefier or nozzle tip portion of the second nozzle cartridge to a point below a liquefaction temperature of the build material. At 760, the heating can include heating the liquefier or nozzle tip portion of the nozzle cartridge to the liquefaction temperature such that the build material can flow from the nozzle tip. At 770, the method 700 can continue by dispensing the build material from the second nozzle cartridge.

The method 700 described generally in the example of FIG. 7 can be expanded to include multiple additional nozzle cartridges, such as corresponding to one or more nozzle cartridge trays, or one or more extrusion head assemblies. For example, a build process can use at least three different nozzle cartridges to dispense at least three different materials (e.g., a support material, a first model material having a first characteristic, and a second model material having a different second characteristic). While the second nozzle cartridge dispenses material at 770, or after the second nozzle cartridge completes a build operation, a third nozzle cartridge can be preheated, such as in an area of the system outside of a build area, such as in a nozzle cartridge tray. When the third nozzle cartridge is sufficiently preheated, and when the second nozzle cartridge completes its corresponding portion of the build process, the third nozzle cartridge can be retrieved and positioned in the extrusion head assembly for use in the build process. The build process can continue using additional nozzle cartridges, or by using a previously used nozzle cartridge for a subsequent portion of the build process.

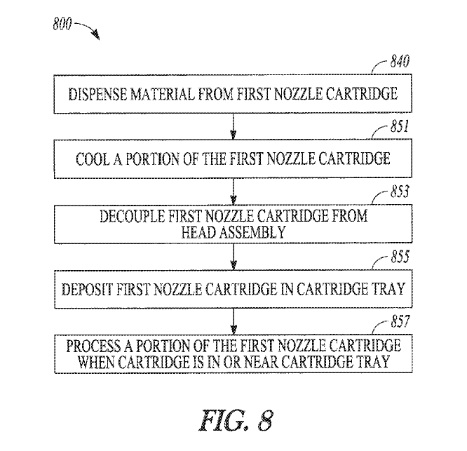

FIG. 8 illustrates generally an example of a method 800 that can include cooling a nozzle cartridge. At 840, a first nozzle cartridge can be used to dispense a first material in a build area of an additive manufacturing system, such as described above in the example of FIG. 7 at 740. At 851, at least a portion of the first nozzle cartridge can optionally be cooled, such as to solidify a portion of the build material at the nozzle tip, or at another location in the nozzle cartridge, to inhibit the build material from flowing from the nozzle cartridge. In an example, cooling the portion of the first nozzle cartridge at 851 can include removing or suspending (e.g., switching off) a heat source that is configured to increase a temperature at the nozzle tip. In an example, cooling the portion of the first nozzle cartridge at 851 can include removing a heat source or providing some form of active cooling at the nozzle tip, or at some other portion of the nozzle cartridge, to cool the build material and thereby inhibit any of the build material from flowing from the first nozzle cartridge.

At 853, the method 800 can include decoupling the first nozzle cartridge from the head assembly. Decoupling the first nozzle cartridge can include mechanically releasing the first nozzle cartridge from a chassis on an extrusion head assembly to which the first nozzle cartridge is mounted. For example, a portion of the chassis can be hinged or otherwise configured to fold away from the first nozzle cartridge. In some examples, a mechanical feature such as a depressible pin can be used at the extrusion head assembly to mate with a corresponding recess or other feature in the first nozzle cartridge to retain the first nozzle cartridge at the extrusion head assembly. The pin can be retracted, such as automatically by the extrusion head assembly, or in response to a removal force provided by a nozzle cartridge removal device. In some examples, the pin can be spring loaded, and the removal force provided by a nozzle cartridge removal device can be sufficient to overcome a retention force provided by the spring loaded pin.

In an example, decoupling the first nozzle cartridge at 853 can include electrically decoupling or removing one or more electrical contacts between the first nozzle cartridge and the extrusion head assembly. In some examples, the electrical contacts on one or both of the first nozzle cartridge and the extrusion head assembly can include spring contacts such that contacts are in abutting contact when the first nozzle cartridge is installed in the chassis of the extrusion head assembly. In an example, the first nozzle cartridge and the extrusion head assembly can include respective portions of an electrical connector having respective mechanical housing portions that are configured to matingly engage when the first nozzle cartridge is installed in a chassis in the extrusion head assembly.

Decoupling the first nozzle cartridge at 853 can include using a robotic arm or other mechanical device to retrieve and separate the first nozzle cartridge from the extrusion head assembly. In an example, the robotic arm can perform one or more release functions at the extrusion head assembly before removing the first nozzle cartridge from the extrusion head assembly. For example, a first portion of the robotic arm can depress a release switch or open a portion of a cartridge chassis before a second portion of the robotic arm receives the first nozzle cartridge. An example of a robotic arm is shown and described above in the example of FIG. 6, although other automated embodiments having pick-and-place functionality can additionally or alternatively be used.

At 855, the method 800 can include depositing the first nozzle cartridge in a nozzle cartridge tray. The depositing the first nozzle cartridge at 855 can optionally include using the same or different robot or automation device as was used at 853 to decouple the first nozzle cartridge from the extrusion head assembly. The nozzle cartridge tray can optionally include a passive tray or other holding device for receiving one or more nozzle cartridges, or the nozzle cartridge tray can have some active functionality as described herein. For example, the nozzle cartridge tray can include a heating, cooling, cleaning, or other processing capability for adjusting a characteristic of one or more nozzle cartridges disposed in or near the tray.

At 857, the method 800 can include processing a portion of the first nozzle cartridge when the cartridge is in or near the nozzle cartridge tray. Processing a portion of the first nozzle cartridge can include, among other things, adjusting a temperature of a portion of the cartridge, cleaning a portion of the cartridge, changing a material for use with the cartridge, or some other process involving the first nozzle cartridge. For example, adjusting a temperature at 857 can include maintaining a preheated condition for the first nozzle cartridge, such as when the first nozzle cartridge is to be used in a subsequent portion of a build process. Adjusting the temperature at 857 can include cooling a portion of the first nozzle cartridge, such as when the first nozzle cartridge completes its corresponding portion of a build process, and the first nozzle cartridge is not indicated for subsequent use, such as for longer than some specified duration. Adjusting the temperature at 857 can include heating a portion of the first nozzle cartridge, such as to clean a portion of the cartridge by melting or purging any unused material from the cartridge. In an example, processing the first nozzle cartridge at 857 can include purging unused material from the cartridge using an air supply, a liquid such as water or a solvent, or by using a drive assembly in the nozzle cartridge to expel any remaining or unwanted material out of the cartridge. In an example, rotation of one or more drive wheels can be changed from a build rotation direction to an opposite purge rotation direction to remove any unused filament material from a nozzle cartridge.

Processing the first nozzle cartridge at 857 can include when the cartridge is disposed in the cartridge tray or near the cartridge tray. In some examples, a nozzle cartridge can be locked or secured in a receptacle in a cartridge tray, such as using a mechanical device or vacuum device, and the nozzle cartridge can be processed at 857 after the nozzle cartridge is secured. In an example, the robotic arm can suspend the first nozzle cartridge over a portion of the cartridge tray, or over a specified receptacle in the cartridge tray, as the nozzle cartridge is processed at 857. For example, the first nozzle cartridge can be cooled or heated by an airflow directed toward the first nozzle cartridge when the nozzle cartridge is positioned near or above a portion of the cartridge tray. When the first nozzle cartridge is sufficiently cooled, for example after a specified period elapses or after a temperature sensor indicates that a target cartridge temperature is attained, then the first nozzle cartridge can be positioned in the cartridge tray.

Polymeric materials that can be used according to the systems, devices, and methods described herein can include high-performance engineering thermoplastic polymers such as polycarbonate-based polymers (PC), polymethyl methacrylate polymers (PMMA), polyethylene terephthalate polymers (PET), polybutylene terephthalate polymers (PBT), styrene polymers, polyetherimide (PEI, Ultem), acrylic-styrene-acrylonitrile polymers (ASA), and acrylonitrile-butadiene-styrene polymers (ABS). Engineering thermoplastic polymers can be used because they have a relatively high flexural modulus.

In particular, polycarbonate (PC) can be a useful engineering thermoplastic for use with the additive manufacturing systems described herein due to its good impact and clarity properties. In a specific embodiment, the polycarbonate can be a linear homopolymer containing bisphenol A carbonate units (BPA-PC); a branched, cyanophenyl end-capped bisphenol A homopolycarbonate produced via interfacial polymerization, containing 3 mol % 1,1,1-tris(4-hydroxyphenyl)ethane (THPE) branching agent, commercially available under the trade name LEXAN CFR from the Innovative Plastics division of SABIC; a poly(carbonate-siloxane) comprising bisphenol A carbonate units and siloxane units, for example blocks containing 5 to 200 dimethylsiloxane units, such as those commercially available under the trade name LEXAN EXL from the Innovative Plastics division of SABIC. Other specific polycarbonates that can be used include poly(ester-carbonate)s comprising bisphenol A carbonate units and isophthalate-terephthalate-bisphenol A ester units, also commonly referred to as poly(carbonate-ester)s (PCE) poly(phthalate-carbonate)s (PPC) depending on the relative ratio of carbonate units and ester units. Poly(aliphatic ester-carbonate)s can be used, such as those comprising bisphenol A carbonate units and sebacic acid-bisphenol A ester units, such as those commercially available under the trade name LEXAN HFD from the Innovative Plastics division of SABIC. Other specific copolycarbonate includes bisphenol A and bulky bisphenol carbonate units, i.e., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer) (commercially available under the trade name LEXAN XHT from the Innovative Plastics division of SABIC), a copolymer comprising bisphenol A carbonate units and 1,1-bis(4-hydroxy-3-methylphenyl)cyclohexane carbonate units (a BPA-DMBPC copolymer), and a copolymer comprising bisphenol A carbonate units and isophorone bisphenol carbonate units (available, for example, under the trade name APEC from Bayer).

Polycarbonates and poly(ester-carbonate)s can be manufactured by processes such as interfacial polymerization and melt polymerization.

The polycarbonates can have an intrinsic viscosity, as determined in chloroform at 25° C., of 0.3 to 1.5 deciliters per gram (dl/gm), specifically 0.45 to 1.0 dl/gm. The polycarbonates can have a weight average molecular weight of 10,000 to 200,000 Daltons, specifically 20,000 to 100,000 Daltons, as measured by gel permeation chromatography (GPC), using a crosslinked styrene-divinylbenzene column and calibrated to polycarbonate references. GPC samples are prepared at a concentration of 1 mg per ml, and are eluted at a flow rate of 1.5 ml per minute.

In addition to the polycarbonate as described above, the polycarbonate compositions can comprise a cycloaliphatic polyester of formula (5),

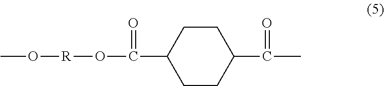

wherein R is a C2-12 alkylene or a C3-12 cycloalkylene, specifically a C2-6 alkylene or a C5-6 cycloalkylene. In a specific embodiment, the cycloaliphatic polyester is a poly(1,4-cyclohexanedimethanol-1,4-cyclohexanedicarboxylate) (PCCD) having recurring units of formula (6).

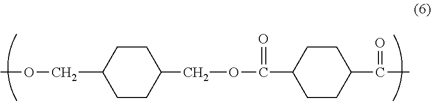

The 1,4-cyclohexanedimethylene group can be derived from 1,4-cyclohexanedimethanol (which includes chemical equivalents thereof), and cyclohexanedicarboxylate (which includes a chemical equivalent thereof. The polyester can comprise the cis-isomer, the trans-isomer, or a combination comprising at least one of the foregoing isomers.

The cycloaliphatic polyester can have an intrinsic viscosity, as determined in chloroform at 25 C, of 0.3 to 1.5 deciliters per gram (dl/gm), specifically 0.45 to 1.0 dl/gm. The polycarbonates can have a weight average molecular weight of 10,000 to 200,000 Daltons, specifically 30,000 to 100,000 Daltons, as measured by gel permeation chromatography (GPC), using a crosslinked styrene-divinylbenzene column.

The polycarbonate and polyester can be used in a weight ratio of 10:1 to 1:10, 10:1 to 1:8, 10:1 to 1:5, 10:1 to 1:1 or 9:1 to 1:1, depending on the function and properties desired. In an embodiment, the composition comprises 5 wt. % to 95 wt. %, 20 wt. % to 95 wt %, 40 wt. % to 95 wt. %, 50 wt. % to 95 wt. %, or 50 wt. % to 90 wt. % of the polycarbonate and 5 wt. % to 95 wt. %, 5 wt. % to 80 wt. %, 5 wt. % to 60 wt. %, 5 wt. % to 50 wt. %, or 10 wt. % to 50 wt. % of the polyester, based on the total weight of the composition.

Dyes can be applied to the polymeric material to provide for a desired color or color-enhancing effect to the polymeric material. Wen et al., in Provisional U.S. Patent Application No. 61/931,033, filed on Jan. 24, 2014, includes systems and methods for using photochromic dyes in engineering plastics.

An additive composition can be used in the photochromic polycarbonate compositions. The additive composition can comprise one or more additives selected to achieve a desired property, with the proviso that the additive(s) are also selected so as to not overly significantly adversely affect a desired property of the composition, in particular the photochromic properties. The additive composition or individual additives can be mixed at a suitable time during the mixing of the components for forming the composition. The additive can be soluble or non-soluble in polycarbonate.

The additive composition can include an impact modifier, flow modifier, antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination comprising one or more of the foregoing. For example, a combination of an antioxidant, heat stabilizer, mold release agent, and ultraviolet light stabilizer can be used. In general, the additives are used in the amounts generally known to be effective. For example, the total amount of the additive composition (other than any impact modifier, filler, or reinforcing agent) can be 0.001 to 10.0 wt. %, or 0.01 to 5 wt. %, 0.01 to 0.2 wt. %, each based on the total weight of the polymer in the composition.

Heat stabilizer additives can include, but is not limited to, organophosphites (e.g. triphenyl phosphite, tris-(2,6-dimethylphenyl)phosphite, tris-(mixed mono- and di-nonylphenyl)phosphite or the like), phosphonates (e.g, dimethylbenzene phosphonate or the like), phosphates (e.g., trimethyl phosphate, or the like), or combinations comprising at least one of the foregoing heat stabilizers. The heat stabilizer can be tris(2,4-di-t-butylphenyl) phosphate available as IRGAPHOSTM 168. Heat stabilizers are generally used in amounts of 0.01 to 5 wt %, based on the total weight of polymer in the composition.

Light stabilizers, in particular ultraviolet light (UV) absorbing additives, also referred to as UV stabilizers, can include, but is not limited to, hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB UV-3638 from Cytec), aryl salicylates, hydroxybenzotriazoles (e.g., 2-(2-hydroxy-5-methylphenyl)benzotriazole, 2-(2-hydroxy-5-tert-octylphenyl)benzotriazole, and 2-(2H-benzotriazol-2-yl)-4-(1,1,3,3-tetramethylbutyl)-phenol, commercially available under the trade name CYASORB 5411 from Cytec) or combinations comprising at least one of the foregoing light stabilizers. The UV stabilizers can be present in an amount of 0.01 to 1 wt %, specifically, 0.1 to 0.5 wt %, and more specifically, 0.15 to 0.4 wt %, based upon the total weight of polymer in the composition.

Antioxidant additives can include, but are not limited to, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)] methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or combinations comprising at least one of the foregoing antioxidants. Antioxidants are used in amounts of 0.01 to 0.1 parts by weight, based on 100 parts by weight of the total composition, excluding any filler.

There is considerable overlap among plasticizers, lubricants, and mold release agents, which include, for example, glycerol tristearate (GTS), phthalic acid esters (e.g, octyl-4,5-epoxy-hexahydrophthalate), tris-(octoxycarbonylethyl)isocyanurate, tristearin, di- or polyfunctional aromatic phosphates (e.g, resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); esters, for example, fatty acid esters (e.g, alkyl stearyl esters, such as, methyl stearate, stearyl stearate, and the like), waxes (e.g, beeswax, montan wax, paraffin wax, or the like), or combinations comprising at least one of the foregoing plasticizers, lubricants, and mold release agents. These are generally used in amounts of 0.01 to 5 wt %, based on the total weight of the polymer in the composition.

In certain embodiments, the photochromic polycarbonate compositions can comprise phosphoric acid. Without wishing to be bound by theory, it is believed that the polycarbonate may react with the cycloaliphatic polyester through transesterification causing the degradation of the polymers and the presence of phosphoric acid can effectively prevent this transesterification thus stabilizing the photochromic polycarbonate compositions. The amount of phosphoric acid added to the photochromic polycarbonate compositions can be, for example, 0.001 to 0.5 wt %, specifically 0.01 to 0.1 wt % based on the total weight of the composition.

Methods for forming the photochromic polycarbonate compositions can vary, but in an advantageous feature, include the photochromic dye in the bulk polymer composition. In an embodiment, the polymers can be combined (e.g., blended) with any additives (e.g., a mold release agent) such as in a screw-type extruder. The polymers, dye, and any additives can be combined in any order, and in form, for example, powder, granular, filamentous, as a masterbatch, and the like. Transparent compositions can be produced by manipulation of the process used to manufacture the photochromic polycarbonate composition. One example of such a process to produce transparent photochromic polycarbonate compositions is described in U.S. Pat. No. 7,767,738.

The photochromic polycarbonate compositions can have good melt viscosities, which aid processing. The photochromic polycarbonate compositions can have a melt volume flow rate (MVR, cubic centimeter per 10 minutes (cc/10 min)), of 4 to 30, greater than or equal to 12, greater than or equal to 10, greater than or equal to 15, greater than or equal to 16, greater than or equal to 17, greater than or equal to 18, greater than or equal to 19, or greater than or equal to 20 cc/min, measured at 300° C./1.2 Kg at 360 second dwell according to ISO 1133. The same or similar values can be obtained in articles having a wide range of thicknesses, for example from 0.1 to 10 mm, or 0.5 to 5 mm.

The photochromic polycarbonate compositions can have excellent impact properties, in particular multiaxial impact (MAI) and ductility, which provides information on how the compositions behave under multiaxial deformation conditions. The deformation applied can be a high-speed puncture. Properties reported include total energy absorbed, which is expressed in Joules (J) and ductility of parts in percent (% D) based on whether the part fractured in a brittle or ductile manner. A ductile part shows yielding where it is penetrated by the tip, a brittle part splits into pieces or has a section punched out that shows no yielding. The photochromic polycarbonate compositions can have an MAI equal to or higher than 100 J, determined at 23° C. at an impact speed of 4.4 m/second in accordance with ISO 6603 on discs with a thickness of 3.2 mm. The compositions can have a ductility in multiaxial impact of 80% and higher, determined at 23° C. at an impact speed of 4.4 m/second in accordance with ISO 6603 on discs with a thickness of 3.2 mm. The same or similar values can be obtained in articles having a wide range of thicknesses, for example from 0.1 to 10 mm, but particularly at 0.5 to 5 mm.

The photochromic polycarbonate compositions can have excellent impact strength. For example, an article molded from the photochromic polycarbonate compositions can have a notched Izod impact of greater than 10 kJ/m2 as measured according to ISO 180/1A at 23° C., 5.5 J, on impact bars with a 4 mm thickness. The same or similar values can be obtained in articles having a wide range of thicknesses, for example from 0.1 to 10 mm, but particularly at 0.5 to 5 mm.

The photochromic polycarbonate compositions can be formulated to have a haze less than 3%, or less than 2%, and a transmission greater than 80%, each measured using the color space CIE1931 (Illuminant C and a 2° observer) or according to ASTM D 1003 (2007) using illuminant C at a 0.062 inch (1.5 mm) thickness. In some embodiments, the photochromic polycarbonate compositions can be formulated such that an article molded from the composition has both a haze less of than 3% and a transmission of greater than 80%, each measured using the color space CIE1931 (Illuminant C and a 2° observer) or according to ASTM D 1003 (2007) using illuminant C at a 0.062 inch (1.5 mm) thickness. In some embodiments the articles can have all three of a haze less of than 3%, a transmission of greater than 85%, and an MAI equal to or higher than 100 J, determined at 23° C. at an impact speed of 4.4 m/second in accordance with ISO 6603 on discs with a thickness of 1.5 mm.

The photochromic polycarbonate compositions can have a flexural modulus of less than 3,000 MPa, less than 2,500 MPa, or less than 2,200 MPa measured according to ASTM D790 (2010) with the speed of 1.27 mm/min. The photochromic polycarbonate compositions can further have a delta a* value of 0.1 to 10 measured on Color Eye 7000A according to ASTM 6290-98.

### Various Notes & Examples

Example 1 can include or use subject matter (such as an apparatus, a method, a means for performing acts, or a device readable medium including instructions that, when performed by the device, can cause the device to perform acts), such as can include or use a nozzle cartridge tray for use with an additive manufacturing system. In Example 1, the nozzle cartridge tray includes at least two nozzle cartridge receptacles each configured to receive respective nozzle cartridges, and each of the respective nozzle cartridges includes a nozzle tip for dispensing a material and a filament conduit for conveying a material from a material source to the nozzle tip. In Example 1, the tray can include a temperature control device for adjusting a temperature of at least a portion of a selected nozzle cartridge when the selected nozzle cartridge is disposed in or near the nozzle cartridge tray. The nozzle cartridge tray can optionally be located outside of a build area of the additive manufacturing system.

Example 2 can include, or can optionally be combined with the subject matter of Example 1, to optionally include the temperature control device configured to selectively adjust the temperature of at least the portion of the selected nozzle cartridge when the selected nozzle cartridge is disposed in or near its corresponding nozzle cartridge receptacle in the tray.

Example 3 can include, or can optionally be combined with the subject matter of one or any combination of Examples 1 or 2 to optionally include, as the temperature control device, a heating device for selectively heating at least the portion of the selected nozzle cartridge.

Example 4 can include, or can optionally be combined with the subject matter of Example 3, to optionally include the heating device configured to heat at least the portion of the selected nozzle cartridge such that the material in the filament conduit of the selected nozzle cartridge approaches a fluid state.

Example 5 can include, or can optionally be combined with the subject matter of one or any combination of Examples 3 or 4 to optionally include, as the heating device, at least one of an induction heating system, a resistive heating system, a conduction heating system, or a radiant heating system.

Example 6 can include, or can optionally be combined with the subject matter of Example 5, to optionally include the selected nozzle cartridge as a portion of the induction heating system.

Example 7 can include, or can optionally be combined with the subject matter of one or any combination of Examples 1 or 2 to optionally include, as the temperature control device, a cooling device for selectively cooling at least the portion of the selected nozzle cartridge.

Example 8 can include, or can optionally be combined with the subject matter of Example 7, to optionally include, as the temperature control device, a heating device for selectively heating at least the portion of the selected nozzle cartridge.

Example 9 can include, or can optionally be combined with the subject matter of Example 7, to optionally include the cooling device configured to cool at least the portion of the selected nozzle cartridge such that the material in the filament conduit of the selected nozzle cartridge approaches a non-fluid state.

Example 10 can include, or can optionally be combined with the subject matter of one or any combination of Examples 1 through 9 to optionally include the temperature control device configured to selectively adjust a temperature of at least one of the nozzle cartridge receptacles.

Example 11 can include or use subject matter (such as an apparatus, a method, a means for performing acts, or a device readable medium including instructions that, when performed by the device, can cause the device to perform acts), such as can include or use an additive manufacturing system with an extrusion head assembly configured to detachably receive a nozzle cartridge, the extrusion head assembly movable along vertical or horizontal axes within a build area, and a nozzle cartridge tray for storing multiple nozzle cartridges outside of the build area. Example 11 can include a temperature control device configured to adjust a temperature of at least a portion of a nozzle cartridge, selected from the nozzle cartridge tray, when the selected nozzle cartridge is positioned outside of the build area. Example 11 can further include a robot or robotic arm configured to move the selected nozzle cartridge between the extrusion head assembly and the nozzle cartridge tray.

Example 12 can include, or can optionally be combined with the subject matter of Example 11, to optionally include the temperature control device configured to adjust the temperature of at least the portion of the selected nozzle cartridge when the selected nozzle cartridge is detached from the extrusion head assembly and when the nozzle cartridge is disposed in or near the cartridge tray.

Example 13 can include, or can optionally be combined with the subject matter of one or any combination of Examples 11 or 12 to optionally include the robotic arm configured to exchange a first nozzle cartridge from the extrusion head assembly with a second nozzle cartridge from the nozzle cartridge tray.

Example 14 can include, or can optionally be combined with the subject matter of one or any combination of Examples 11 or 12 to optionally include the robotic arm configured to move the selected nozzle cartridge from the nozzle cartridge tray to the extrusion head assembly.

Example 15 can include, or can optionally be combined with the subject matter of one or any combination of Examples 11 or 12 to optionally include the robotic arm configured to move the selected nozzle cartridge from the nozzle cartridge tray to the temperature control device and then to the extrusion head assembly.

Example 16 can include, or can optionally be combined with the subject matter of one or any combination of Examples 11 or 12 to optionally include the robotic arm configured to move the selected nozzle cartridge from the extrusion head assembly to the nozzle cartridge tray.

Example 17 can include, or can optionally be combined with the subject matter of one or any combination of Examples 11 or 12 to optionally include the robotic arm configured to move the selected nozzle cartridge from the extrusion head assembly to the temperature control device and then to the nozzle cartridge tray.

Example 18 can include, or can optionally be combined with the subject matter of one or any combination of Examples 11 through 17 to optionally include the temperature control device, including a heating device configured to heat the portion of the selected nozzle cartridge when the selected nozzle cartridge is detached from the extrusion head assembly.

Example 19 can include, or can optionally be combined with the subject matter of one or any combination of Examples 11 through 18 to optionally include the temperature control device, including a cooling device configured to cool the portion of the selected nozzle cartridge when the selected nozzle cartridge is detached from the extrusion head assembly.

Example 20 can include, or can optionally be combined with the subject matter of one or any combination of Examples 11 through 19 to optionally include the nozzle cartridge tray with the temperature control device.

Example 21 can include, or can optionally be combined with the subject matter of Example 11, to optionally include the temperature control device configured to adjust a temperature of at least a portion of a first nozzle cartridge when a second nozzle cartridge is coupled to the extrusion head assembly.

Example 22 can include, or can optionally be combined with the subject matter of Example 21, to optionally include the temperature control device configured to adjust the temperature of at least the portion of the first nozzle cartridge when the second nozzle cartridge is engaged in a material deposition process.

Example 23 can include, or can optionally be combined with the subject matter of one or any combination of Examples 11 through 22 to optionally include the extrusion head assembly, including a liquefier configured to heat a portion of a selected nozzle cartridge to a build temperature when the selected nozzle cartridge is coupled to the extrusion head assembly.

Example 24 can include, or can optionally be combined with the subject matter of Example 23, to optionally include the selected nozzle cartridge, including a drive mechanism configured to drive material from a filament conduit to the liquefier.

Example 25 can include, or can optionally be combined with the subject matter of one or any combination of Examples 11 through 23 to optionally include the extrusion head assembly, including a drive mechanism configured to drive material through a filament conduit of the selected nozzle cartridge when the selected nozzle cartridge is coupled to the extrusion head assembly.

Example 26 can include, or can optionally be combined with the subject matter of one or any combination of Examples 11 through 25 to optionally include a receiving surface within the build area, the receiving surface configured to receive material from a nozzle tip of the selected nozzle cartridge when the selected nozzle cartridge is coupled to the extrusion head assembly and when the extrusion head assembly is positioned in the build area.

Example 27 can include or use subject matter (such as an apparatus, a method, a means for performing acts, or a device readable medium including instructions that, when performed by the device, can cause the device to perform acts), such as can include or use an additive manufacturing system, including an extrusion head assembly configured to detachably receive at least one nozzle cartridge, the extrusion head assembly movable along vertical or horizontal axes within a build area, and a first nozzle cartridge including a temperature control device that is configured to adjust a temperature of a portion of the first nozzle cartridge when the first nozzle cartridge is decoupled from the extrusion head assembly. Example 27 can include a robotic arm having a tool end, wherein the tool end is movable between the extrusion head assembly and a nozzle cartridge tray, and wherein the tool end is configured to exchange the first nozzle cartridge from the extrusion head assembly with a second nozzle cartridge in the nozzle cartridge tray.

Example 28 can include, or can optionally be combined with the subject matter of Example 27, to optionally include the first nozzle cartridge includes the temperature control device including a heating device.

Example 29 can include, or can optionally be combined with the subject matter of one or any combination of Examples 27 or 28 to optionally include the first nozzle cartridge with the temperature control device including a cooling device.

Example 30 can include, or can optionally be combined with the subject matter of Example 27, to optionally include the temperature control device with the first nozzle cartridge, the temperature control device including both a heating device and a cooling device, and the devices configured to respectively heat and cool the same or different portions of the first nozzle cartridge when the first nozzle cartridge is decoupled from the extrusion head assembly.

Example 31 can include or use subject matter (such as an apparatus, a method, a means for performing acts, or a device readable medium including instructions that, when performed by the device, can cause the device to perform acts), such as can include or use a method for creating a three-dimensional part composite using an additive manufacturing system, the method including preheating at least a portion of a first nozzle cartridge outside of a build area of an additive manufacturing system, the first nozzle cartridge including a first nozzle tip for dispensing a first material and a first filament conduit for conveying the first material from a first material source to the first nozzle tip, coupling the first nozzle cartridge to an extrusion head assembly using a tool end of a robotic arm, the extrusion head assembly movable within the build area, heating a same or different portion of the first nozzle cartridge within the build area to liquefy a portion of the first material, and dispensing the liquefied portion of the first material from the first nozzle tip to create the three-dimensional part composite in the build area.

Example 32 can include, or can optionally be combined with the subject matter of Example 31, to optionally include preheating at least a portion of a second nozzle cartridge outside of the build area, the second nozzle cartridge including a second nozzle tip for dispensing a second material, and the second nozzle cartridge including a second filament conduit for conveying the second material from a second material source to the second nozzle tip. Example 32 can include exchanging the first nozzle cartridge with the second nozzle cartridge at the extrusion head assembly using the tool end of the robotic arm, heating the same or a different portion of the second nozzle cartridge within the build area to liquefy a portion of the second material, and dispensing the liquefied portion of the second material from the second nozzle tip to create the three-dimensional part composite in the build area.

Example 33 can include, or can optionally be combined with the subject matter of one or any combination of Examples 31 or 32 to optionally include preheating the first nozzle cartridge when the nozzle cartridge is disposed in or near a nozzle cartridge tray outside of the build area.

Example 34 can include, or can optionally be combined with the subject matter of Example 33, to optionally include heating a portion of a cartridge receptacle in the cartridge tray that corresponds to the first nozzle cartridge.

Example 35 can include, or can optionally be combined with the subject matter of Example 31, to optionally include cooling the same or a different portion of the first nozzle cartridge to solidify a portion of the first material after at least a portion of a build process, decoupling the first nozzle cartridge from the extrusion head assembly using the tool end of the robotic arm, and depositing the first nozzle cartridge in a first receptacle in a cartridge tray.

Example 36 can include, or can optionally be combined with the subject matter of Example 35, to optionally include preheating at least a portion of a second nozzle cartridge when the second nozzle cartridge is located in or near a second receptacle in the cartridge tray, the preheating occurring during at least one of the dispensing the first material from the first nozzle tip, the cooling the first nozzle cartridge, the decoupling the first nozzle cartridge, or the depositing the first nozzle cartridge in the first receptacle.

Example 37 can include, or can optionally be combined with the subject matter of Example 31, to optionally include using an induction heating system or configuration for at least one of the preheating or the heating.

Each of these non-limiting examples can stand on its own, or can be combined in various permutations or combinations with one or more of the other examples.

All cited patents, patent applications, and other references are incorporated herein by reference in their entirety. In the event of inconsistent usages between this document and any documents so incorporated by reference, the usage in this document controls.

Method examples described herein can be machine or computer-implemented at least in part. For example, the control circuit 150, or some other controller or processor circuit, can be used to implement at least a portion of one or more of the methods discussed herein. Some examples can include a tangible, computer-readable medium or machine-readable medium encoded with instructions that are operable to configure an electronic device to perform methods as described in the above examples. An implementation of such methods can include code, such as microcode, assembly language code, a higher-level language code, or the like. Such code can include computer-readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An additive manufacturing system comprising:
nozzle cartridges; and
a nozzle cartridge tray comprising:
at least two nozzle cartridge receptacles each configured to receive the respective nozzle cartridges, each of the respective nozzle cartridges including a nozzle tip for dispensing a material and a filament conduit for conveying a material from a material source to the nozzle tip; and
a temperature control device for adjusting a temperature of at least a portion of a selected nozzle cartridge when the selected nozzle cartridge is disposed in or near the nozzle cartridge tray;
wherein the nozzle cartridge tray is for use outside of a build area of the additive manufacturing system.

2. The additive manufacturing system of claim 1, wherein the temperature control device is configured to selectively adjust the temperature of at least the portion of the selected nozzle cartridge when the selected nozzle cartridge is disposed in or near its corresponding nozzle cartridge receptacle in the tray.

3. The additive manufacturing system of claim 1, wherein the temperature control device comprises a heating device for selectively heating at least the portion of the selected nozzle cartridge.

4. The additive manufacturing system of claim 3, wherein the heating device comprises an induction heating system, and wherein the selected nozzle cartridge comprises a portion of the induction heating system.

5. The additive manufacturing system of claim 1, wherein the temperature control device comprises a cooling device for selectively cooling at least the portion of the selected nozzle cartridge.

6. An additive manufacturing system comprising:
an extrusion head assembly configured to detachably receive a nozzle cartridge, the extrusion head assembly movable along vertical or horizontal axes within a build area;
a nozzle cartridge tray for storing multiple nozzle cartridges outside of the build area;
a temperature control device configured to adjust a temperature of at least a portion of a nozzle cartridge, selected from the nozzle cartridge tray, when the selected nozzle cartridge is positioned in or near the nozzle cartridge tray and outside of the build area; and
a robotic arm configured to move the selected nozzle cartridge between the extrusion head assembly and the nozzle cartridge tray.

7. The system of claim 6, wherein the temperature control device is configured to adjust the temperature of at least the portion of the selected nozzle cartridge when the selected nozzle cartridge is detached from the extrusion head assembly and when the nozzle cartridge is disposed in or near the cartridge tray.

8. The system of claim 7, wherein the robotic arm is configured to exchange a first nozzle cartridge from the extrusion head assembly with a second nozzle cartridge from the nozzle cartridge tray.

9. The system of claim 7, wherein the robotic arm is configured to:
move the selected nozzle cartridge from the nozzle cartridge tray to the extrusion head assembly;
move the selected nozzle cartridge from the nozzle cartridge tray to the temperature control device and then to the extrusion head assembly;
move the selected nozzle cartridge from the extrusion head assembly to the nozzle cartridge tray; or
move the selected nozzle cartridge from the extrusion head assembly to the temperature control device and then to the nozzle cartridge tray.

10. The system of claim 7, wherein the temperature control device includes a heating device configured to heat the portion of the selected nozzle cartridge when the selected nozzle cartridge is detached from the extrusion head assembly.

11. The system of claim 7, wherein the temperature control device includes a cooling device configured to cool the portion of the selected nozzle cartridge when the selected nozzle cartridge is detached from the extrusion head assembly.

12. The system of claim 7, wherein the nozzle cartridge tray includes the temperature control device.

13. The system of claim 7, wherein the extrusion head assembly comprises a liquefier configured to heat a portion of a selected nozzle cartridge to a build temperature when the selected nozzle cartridge is coupled to the extrusion head assembly, and wherein the selected nozzle cartridge comprises a drive mechanism configured to drive material from a filament conduit to the liquefier.

14. A method for creating a three-dimensional part composite using an additive manufacturing system, the method comprising:
selecting a first nozzle cartridge from a nozzle cartridge tray
preheating at least a portion of the first nozzle cartridge is in or near a nozzle cartridge tray and outside of a build area of the additive manufacturing system, the first nozzle cartridge including a first nozzle tip for dispensing a first material and a first filament conduit for conveying the first material from a first material source to the first nozzle tip;
coupling the first nozzle cartridge to an extrusion head assembly using a tool end of a robotic arm, the extrusion head assembly movable within the build area;
heating a same or different portion of the first nozzle cartridge within the build area to liquefy a portion of the first material; and
dispensing the liquefied portion of the first material from the first nozzle tip to create the three-dimensional part composite in the build area.

15. The method of claim 14, comprising:
preheating at least a portion of a second nozzle cartridge outside of the build area, the second nozzle cartridge including a second nozzle tip for dispensing a second material, and the second nozzle cartridge including a second filament conduit for conveying the second material from a second material source to the second nozzle tip;
exchanging the first nozzle cartridge with the second nozzle cartridge at the extrusion head assembly using the tool end of the robotic arm;
heating the same or a different portion of the second nozzle cartridge within the build area to liquefy a portion of the second material; and
dispensing the liquefied portion of the second material from the second nozzle tip to create the three-dimensional part composite in the build area.
